(19) United States
(12) Patent Application Publication
(10) Pub. No.: US 2019/0087807 A1
(43) Pub. Date: Mar. 21, 2019

(54) METHOD AND APPARATUS FOR PAYMENT USING BEACON

(71) Applicant: Beaconyx Inc., Seoul (KR)

(72) Inventor: Shin-Ho CHOI, Seoul (KR)

(21) Appl. No.: 16/193,185

(22) Filed: Nov. 16, 2018

Related U.S. Application Data
(63) Continuation of application No. PCT/KR2017/005108, filed on May 17, 2017.

(30) Foreign Application Priority Data
May 18, 2016 (KR) 10-2016-0061097
Jun. 21, 2016 (KR) 10-2016-0077273
Jun. 21, 2016 (KR) 10-2016-0077282

(51) Int. Cl. G06Q 20/32; G01S 1/68; G06Q 20/40; H04W 76/10; H04W 24/08

(52) U.S. Cl. CPC G06Q 20/327; G01S 1/68; H04W 24/08; H04W 76/10; G06Q 20/40

(57) ABSTRACT

A payment method and apparatus using a beacon are disclosed. The present disclosure in some embodiments enables bidirectional communication between a payment terminal and a user terminal, and works universally over all user terminals having various operating systems, and facilitates authentication in a short distance but not in a too close range. According to another embodiment of the present disclosure, a payment apparatus using a beacon, which is wired to a merchant terminal and is responsive to the presence of a user terminal within a predetermined range detected by using a range sensor, for establishing a communication channel based on a beacon communication with the user terminal, to relay the settlement-related information between the user terminal and the merchant terminal, and to provide a payment method using a beacon, thereby providing the settlement service more efficiently, while overcoming the limitation of the conventional NFC settlement system.

### CROSS-REFERENCE TO RELATED APPLICATIONS

The present application is a continuation of International Application No. PCT/KR2017/005108, filed May 17, 2017, which is based upon and claims the benefit of priorities from Korean Patent Application Nos. 10-2016-0061097 filed on May 18, 2016; 10-2016-0077273 and 10-2016-0077282, both filed on Jun. 21, 2016. The disclosures of the above-listed applications are hereby incorporated by reference herein in their entireties.

### BACKGROUND OF THE INVENTION

### Technical Field

The present disclosure in some embodiments relates to a method and system for settlement processing using a beacon.

### Background

The statements in this section merely provide background information related to the present disclosure and do not necessarily constitute prior art.

Emerging methods are replacing conventional magnetic card payments or IC (Integrated Circuit) card payments, for authenticating a terminal and settling a payment transaction. In particular, a conventional terminal-based payment method includes a common technique for processing a settlement upon receiving an authentication of a terminal and an affiliated store terminal or merchant terminal, performed through Near Field Communication (NFC). However, the authentication method using NFC has the inconvenience of having to place the terminal close to the merchant terminal at a short distance.

In particular, the NFC settlement method enables data transfer between terminals at a very short distance of about 10 cm by using a non-contact short range wireless communication module. The NFC settlement method works only when bringing the mobile terminal equipped with the NFC function close to the merchant terminal.

The NFC settlement method is inconveniently tied to specific terminal models because different terminals have their proprietary methods of running the NFC function. In addition, the NFC settlement method, which transmits credit card information unidirectionally to a merchant terminal, prohibits the terminal from receiving a transmission of card slip or receipt.

Confined to a specific operating system (OS)-based mobile device equipped with the NFC function, the NFC payment method is prohibitively difficult in practice to be applied to an unspecified number of terminals. For example, the NFC settlement method cannot be used through any other terminals having various operating systems besides one with a specific OS such as Android.

The present disclosure in some embodiments seeks to provide a payment method and system using a beacon, which enable bidirectional communications between a merchant terminal and a user terminal, provide the settlement-related processing for different user terminals having various operating systems, and facilitate authentication at short distance but not in a too close range.

The present disclosure in some other embodiments seeks to provide a payment apparatus using a beacon, which is wired to a merchant terminal and is responsive to the presence of a user terminal within a predetermined range detected by using a range sensor, for establishing a communication channel based on a beacon communication with the user terminal, to relay the settlement-related information between the user terminal and the merchant terminal, and to provide a payment method using a beacon, thereby providing the settlement service more efficiently, while overcoming the limitation of the conventional NFC settlement system.

### SUMMARY OF THE INVENTION

At least one aspect of the present disclosure provides an apparatus for payment using a beacon, including a wireless communication unit configured to transmit a beacon signal externally at a preset signal strength, and receive a connection signal corresponding to the beacon signal from a terminal located nearby, and a control unit configured to control, upon receiving the connection signal, to establish a communication channel based on a beacon communication with the terminal, and a first data processing unit configured to determine whether the authentication information conforms to or matches with a preset format, and generate a matching/mismatching result, and a second data processing unit configured to convert the authentication information and the matching/mismatching result into data packets, and transmit the data packets to the payment terminal through wired communications.

Another aspect of the present disclosure provides a method of performing, by a beacon payment apparatus, a beacon-based settlement, including transmitting a beacon signal externally at a preset signal strength, and receiving a connection signal corresponding to the beacon signal from a terminal located nearby, and controlling, upon receiving the connection signal, to establish a communication channel based on a beacon communication with the terminal, and determining whether the authentication information conforms to or matches with a preset format, and generating a matching/mismatching result, and converting the authentication information and the matching/mismatching result into data packets, and transmitting the data packets to the payment terminal through wired communications.

Yet another aspect of the present disclosure provides a beacon payment apparatus including a first projection formed at one end outside the beacon payment apparatus so as to protrude toward an outward direction having a predetermined acute angle, and a second projection protruding in the same direction as the first projection, and a light emitting unit coupled to a protruding end of the first projection to illuminate an object positioned in a predetermined acute angle direction with an optical signal, and a light receiving unit coupled to a protruding of the second projection to receive an echo signal reflected from the object, corresponding to the optical signalm, and a close-range terminal determination unit configured to determine the object based on the presence or absence of the echo signal reflected from the object within a secured access range in a direction in which the first projection and the second projection are directed.

Yet another aspect of the present disclosure provides a beacon payment apparatus including a first projection formed at one outside end of the beacon payment apparatus so as to protrude upright from the beacon payment apparatus until being bent toward a center of the beacon payment apparatus, and a second projection protruding upright from an opposite outside end of the beacon payment apparatus until being bent toward the center of the beacon payment apparatus, the second projection facing the first projection, and a light emitting unit coupled to a protruding end of the first projection to illuminate an object positioned in a predetermined acute angle direction with an optical signal, and a light receiving unit coupled to a protruding of the second projection to receive an echo signal reflected from the object, corresponding to the optical signal, and a close-range terminal determination unit configured to determine the object based on the presence or absence of the echo signal reflected from the object within a secured access range in a direction in which the first projection and the second projection are directed.

As described above, according to some embodiments of the present disclosure, there is an advantage that bidirectional communication can be made between a merchant terminal and a user terminal. A first embodiment provides settlement-related operations for different user terminals having various operating systems, and facilitates authentication at short distance but not in a too close range.

According to another embodiment of the present disclosure, a beacon payment apparatus capable of bidirectional communication is connected to a conventional merchant terminal, and a settlement service is provided based on beacon communication by using the connected beacon payment apparatus, thereby providing the settlement service more efficiently, while overcoming the limitation of the conventional NFC settlement system. According to a second embodiment, settling a payment transaction immediately provides the terminal with the consequent electronic receipt and the electronic payment history, thereby maximizing the user convenience.

### BRIEF DESCRIPTION OF THE DRAWINGS

FIG. 1 is a schematic diagram of a beacon settlement system according to the first and second embodiments.

FIG. 2 is a diagram for explaining the basic operation of the beacon settlement system according to the first and second embodiments.

FIG. 3 is a detailed block diagram of a beacon payment apparatus according to the first and second embodiments.

FIG. 4 is a schematic block diagram of a configuration of the beacon payment apparatus according to the first embodiment.

FIG. 5 is a flowchart of a method of authenticating a terminal by the beacon payment apparatus according to the first embodiment.

FIG. 6A and FIG. 6B are diagrams of beacon payment apparatuses each including a range sensor, according to the second embodiment.

FIG. 7 is a schematic block diagram of a control unit of the beacon payment apparatus according to the second embodiment.

FIG. 8 is a timing chart for explaining a settlement method performed by the beacon payment apparatus when lacking a range sensor according to the second embodiment.

FIG. 9 is a timing chart for explaining a settlement method performed by the beacon payment apparatus provided with the range sensor according to the second embodiment.

### DESCRIPTION OF THE PREFERRED EMBODIMENTS

Hereinafter, some embodiments of the present disclosure will be described in detail with reference to the accompanying drawings. In the following description, like reference numerals designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, (a), (b), etc., are used solely for the purpose of differentiating one component from the other, not to imply or suggest the substances, the order or sequence of the components. Throughout this specification, when a part “includes” or “comprises” a component, the part is meant to further include other components, not excluding thereof unless specifically stated to the contrary. The terms such as “unit,” “module,” and the like refer to units for processing at least one function or operation, which may be implemented by hardware, software, or a combination thereof.

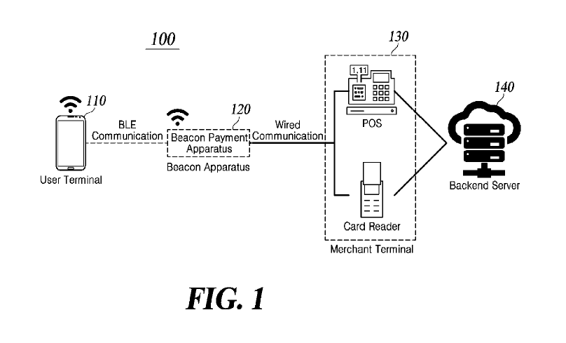

FIG. 1 is a schematic diagram of a beacon settlement system according to the first and second embodiments.

The beacon settlement system 100 according to the first and second embodiments includes a user terminal 110, a beacon payment apparatus 120, a merchant terminal 130 and a backend server 140.

The user terminal 110 refers to an electronic device capable of transmitting and receiving various data according to a user's key operation. The user terminal 110 may include a tablet PC, a laptop, a personal computer (PC), a smart phone, a personal digital assistant (PDA), a mobile communication terminal, or the like.

The user terminal 110 connects to the beacon payment apparatus 120 in Bluetooth communication (Bluetooth Low Energy or BLE), and requests the beacon payment apparatus 120 for authentication. The user terminal 110 interlocks with the merchant terminal 130 via the beacon payment apparatus 120. The user terminal 110 is installed with a settlement processing application. The user terminal 110 utilizes the installed settlement processing software application to provide a settlement processing service for the items purchased by the user. The settlement processing application refers to a kind of software installed in the user terminal 110 so as to cause the user terminal 110 to carry out settlement processing service.

The user terminal 110 attempts to connect with the beacon payment apparatus 120 by using Bluetooth communication. Upon receiving a BLE signal from the beacon payment apparatus 120, the user terminal 110 uses the received BLE signal to determine the distance to the beacon payment apparatus 120. The user terminal 110 determines the distance between the user terminal 110 and the beacon payment apparatus 120 by grasping the received signal strength indication (RSSI) etc. of the received BLE signal. When the distance between itself and the beacon payment apparatus 120 is within a predetermined distance, the user terminal 110 attempts to make a communicative connection with the beacon payment apparatus 120 by transmitting a connection signal thereto. Once establishing a communicative connection with the beacon payment apparatus 120, the user terminal 110 transmits authentication information to the beacon payment apparatus 120. The authentication information is unique information capable of identifying each terminal, and includes a unique identification (ID) possessed by the terminal, the terminal number, the MAC address of the terminal, and the like. The authentication information refers to encrypted information having a packet structure. Data included in the authentication information are optional and not stipulated as to their packet structure and whether to encrypt them. Data transmitted and received between the user terminal 110 and the beacon payment apparatus 120 are encrypted in order to prevent hacking.

The user terminal 110 is used to pay for goods and services purchased by the user. Where the beacon payment apparatus 120 lacks a range sensor, when the user terminal 110 is located within the wireless coverage of the beacon signal transmitted from the beacon payment apparatus 120, it can communicate with the beacon payment apparatus 120. When the user terminal 110 is within the wireless coverage of the beacon payment apparatus 120 and gets close thereto, a beacon-based communication channel is established with the beacon payment apparatus 120. The beacon communication is preferably, but not necessarily, low power Bluetooth communication (BLE).

When the beacon payment apparatus 120 lacks a range sensor, the user terminal 110 detects a beacon signal broadcast from the beacon payment apparatus 120. The user terminal 110 determines, upon detecting the beacon signal, the distance between the user terminal 110 and the beacon payment apparatus 120 by calculating Received Signal Strength Indication (RSSI) of the detected beacon signal. When the distance to the beacon payment apparatus 120 is within a predetermined range, the user terminal 110 transmits a feedback signal corresponding to the beacon signal, to the beacon payment apparatus 120, thereby establishing a beacon-based communication channel with the beacon payment apparatus 120. It is preferable, but not necessary, that the feedback signal includes pre-agreed authentication information to establish a communication channel with the beacon payment apparatus 120.

When the beacon payment apparatus 120 is provided with a range sensor, the user terminal 110 receives, upon recognition thereof within a predetermined range, a connection request transmitted from the beacon payment apparatus 120. The user terminal 110 establishes a beacon-based communication channel with the beacon payment apparatus 120, based on the connection request signal transmitted from the beacon payment apparatus 100.

The user terminal 110 receives settlement request information from the beacon payment apparatus 120 by using a communication channel set up between the user terminal 110 and the beacon payment apparatus 120. Settlement request information includes information on purchased goods, prices of user's purchased goods, the user and the like as previously provided to the beacon payment apparatus 120 from the merchant terminal 130 through wired communication.

The user terminal 110 displays the settlement request information to the user, and receives, from the user, settlement response information corresponding to the settlement request information. The settlement response information may include information on a payment method, information such as a password which has already been set and allows payment to be performed by the relevant payment method.

The user terminal 110 transmits settlement response information to the merchant terminal 130 via the beacon payment apparatus 120. Thereafter, the user terminal 110 receives, from the merchant terminal 130, history information on the payment performed based on the settlement response information, via the beacon payment apparatus 120. The payment history information may include a transaction history and a receipt.

The beacon payment apparatus 120 according to the first and second embodiments transmits and receives data to and from the user terminal 110 by using the communication channel based on the beacon signal. The beacon payment apparatus 120 transmits and receives data to and from the merchant terminal 130 through the wired communication. In other words, the beacon payment apparatus 120 is wired to the merchant terminal 130 and receives settlement request information corresponding to the user terminal 110 from the merchant terminal 130. Upon determining that the user terminal 110 exists within a preset range, the beacon payment apparatus 120 establishes a beacon-based communication channel with the user terminal 110.

The operation of the beacon payment apparatus 120 according to the first embodiment will now be described.

Upon receiving an authentication operation request signal from the backend server 140, the beacon payment apparatus 120 broadcasts a Bluetooth (BLE) signal. Upon receiving a connection signal from the user terminal 110, the beacon payment apparatus 120 establishes a beacon-based communication channel. When receiving the authentication operation request signal from the backend server 140, the beacon payment apparatus 120 broadcasts a beacon signal in all directions so that various terminals can receive it. In transmitting the beacon signal, the beacon payment apparatus 120 incorporates an identifier such as a Universally Unique Identifier (UUID) so that the user terminal 110 can identify the beacon payment apparatus 120. When the beacon payment apparatus 120 receives a connection signal from the user terminal 110 that has received the beacon signal, the beacon payment apparatus 120 establishes a beacon-based communication channel with the user terminal 110. The beacon payment apparatus 120 can transmit and receive information and signals to and from the user terminal 110 with which the communication channel is established. In transmitting the beacon signal to the user terminal 110, the beacon payment apparatus 120 encrypts the beacon signal before it transmits the same. The beacon payment apparatus 120 may control the signal output intensity at the time of broadcasting the beacon signal before establishing the communication channel to be different from the signal output intensity after establishing the communication channel.

The beacon payment apparatus 120 determines whether the format of the authentication information received from the user terminal 110 is appropriate. The beacon payment apparatus 120 determines whether the packet structure of the authentication information matches the packet structure of the format preset and/or whether the encrypted form of the authentication information conforms to or matches with the preset format. When the packet structure of the authentication information does not match the packet structure of the preset format, or the encrypted form of the authentication information does not conform to the preset format, the beacon payment apparatus 120 closes the communication channel it has established with the user terminal 110. When the packet structure of the authentication information received from the user terminal 110 matches the packet structure of the preset format, and the encrypted form of the authentication information matches the preset format, the beacon payment apparatus 120 transmits the matching/mismatching result together with the authentication information to the merchant terminal 130.

The beacon payment apparatus 120 determines whether the authentication information received from the user terminal 110 matches the preset authentication information. From the backend server 140 or another external server (not shown), the beacon payment apparatus 120 receives and stores the authentication information of the terminals registered to utilize payment and other services. For example, when using the beacon settlement system 100 for a billing system, the beacon payment apparatus 120 may receive and stores from the backend server 140 or another external server (not shown), the authentication information of the terminals registered to utilize the billing system. The beacon payment apparatus 120 compares the authentication information received from the user terminal 110 with the stored authentication information, and determines whether they match. When the authentication information matches, the beacon payment apparatus 120 determines that the user terminal 110 is a registered terminal, and allows the same to use payment or other services. When the authentication information does not match, the beacon payment apparatus 120 determines the user terminal 110 to be an unregistered terminal. The beacon payment apparatus 120 transmits the determination to the merchant terminal 130. The merchant terminal 130 performs payment or other services based on the determination.

Hereinafter, the operation of the beacon payment apparatus 120 according to the second embodiment will be described.

The following describes an operation in which the beacon payment apparatus 120 according to the second embodiment determines the presence or absence of the user terminal 110 within a preset range.

When lacking a range sensor, the beacon payment apparatus 120 broadcasts the beacon signal to the outside. The beacon payment apparatus 120 determines the presence or absence of the user terminal 110 within a predetermined range depending on whether the feedback signal is received from the user terminal 110 in response to the beacon signal. When the feedback signal is received, the beacon payment apparatus 120 establishes a beacon-based communication channel with the user terminal 110 based on the received feedback signal. The beacon payment apparatus 120 performs the authentication procedure for the user terminal 110 based on the authentication information included in the feedback signal, and determines whether to maintain the communication channel with the user terminal 110 according to the authentication result.

When provided with a range sensor, the beacon payment apparatus 120 uses the range sensor to determine whether or not the user terminal 110 is present within the preset range. Upon determining the presence of the user terminal 110 within the preset range, the beacon payment apparatus 120 transmits a connection request signal to the user terminal 110, and thereby establishing a beacon-based communication channel with the beacon payment apparatus 120.

When establishing a communication channel with the user terminal 110, the beacon payment apparatus 120 outputs an increased strength of the beacon signal transmitted from the complete antenna 317, from the strength before establishing the communication channel. With such increased output, data can be more efficiently transmitted and received between the beacon payment apparatus 120 and the user terminal 110.

When establishing a communication channel with the user terminal 110, the beacon payment apparatus 120 relays the settlement request information received from the merchant terminal 130 through the established channel to the user terminal 110. Thereafter, the beacon payment apparatus 120 receives settlement response information corresponding to settlement request information from the user terminal 110. The beacon payment apparatus 120 relays the received settlement response information to the merchant terminal 130 so that settlement is performed.

The merchant terminal 130 refers to a payment apparatus such as a point of sales (POS) device, a card reader or credit card payment machine or the like. The merchant terminal 130 is wired to the beacon payment apparatus 120, and transmits the settlement request information corresponding to the user terminal 110 to the beacon payment apparatus 120 through wired communication.

The merchant terminal 130 receives settlement response information transmitted from the user terminal 110 via the beacon payment apparatus 120, and performs settlement based on the received settlement response information. Thereafter, the merchant terminal 130 transmits the payment history information of the proceeded settlement to the user terminal 110 via the beacon payment apparatus 120.

The backend server 130 transmits pre-agreed authentication information to the merchant terminal 130, to perform settlement processing between the user terminal 110 and the merchant terminal 130. The merchant terminal 130 transmits the received authentication information to the beacon payment apparatus 120. As a result, the beacon payment apparatus 120 operates so as to perform the payment process only for a specific terminal that has completed authentication, out of a plurality of terminals.

The merchant terminal 130 is connected to the beacon payment apparatus 120 by wired or wireless communication, and transmits and receives a authentication operation request signal or authentication information. Upon receiving the authentication operation request signal from the backend server 140, the merchant terminal 130 transmits that signal to the beacon payment apparatus 120. In addition, upon receiving the authentication information alone or the conformity result together with the authentication information from the beacon payment apparatus 120, the merchant terminal 130 transmits the same to the backend server 140.

The merchant terminal 130 may receive from the beacon payment apparatus 120 a determination result as to whether or not the terminal itself is a terminal registered to be able to use payment or other services. Based on the result of the determination, the merchant terminal 130 may decide whether to provide settlement or other services. For example, when the beacon settlement system 100 of some embodiments is utilized in combination with a settlement system, the merchant terminal 130 may be implemented as a card reader such as a POS device. When the member shop terminal 130 receives the determination that it is one registered to utilize the settlement service from the beacon payment apparatus 120, it can provide the settlement service to the relevant terminal.

The backend server 140 transmits an authentication operation request signal to the merchant terminal 130. The backend server 140 transmits the authentication operation request signal to the beacon payment apparatus 120 via the merchant terminal 130.

The backend server 140 receives the authentication information alone or the conformity result, in addition to the authentication information from the merchant terminal 130, to determine whether or not the user terminal 110 registered to use the settlement and other services. Here, the conformity result means a result of determination as to whether or not the format of the authentication information received from the terminal determined by the beacon payment apparatus 120 conforms to the format that has been preset. The backend server 140 may receive and store authentication information of terminals that are entitled to use settlement and other services from an external server (not shown). The backend server 140 compares the stored authentication information of the terminals with the authentication information received from the merchant terminal 130, to determine whether or not the user terminal 110 is one registered to use the settlement and other services. Upon receiving the authentication information alone from the merchant terminal 130, the backend server 140 may determine whether or not the format of the received authentication information conforms to the preset format. The backend server 140 transmits the matching/mismatching result or the determination result to the beacon payment apparatus via the merchant terminal 130.

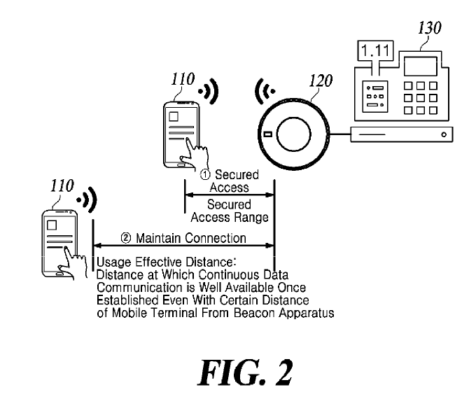

FIG. 2 is a diagram for explaining the basic operation of the beacon settlement system according to the first and second embodiments.

When the beacon payment apparatus 120 receives an authentication operation request signal from the merchant terminal 130, it transmits a beacon signal. At this time, in transmitting the beacon signal, the beacon payment apparatus 120 controls to transmit the beacon signal at or below a preset strength so that the user terminal 110 may receive the beacon signal only when it is located within a preset range. In a situation where the beacon payment apparatus 120 transmits a beacon signal in all directions, when a certain space holds a beacon payment apparatus or a plurality of other apparatuses that transmit a beacon signal, interferences may occur between the beacon signals. Therefore, until when a beacon-based communication channel is established between the beacon payment apparatus 120 and the user terminal 110, the beacon payment apparatus 120 controls to transmit the beacon signal at or below a preset strength.

When establishing a beacon-based communication channel with the user terminal 110, the beacon payment apparatus 120 controls to transmit a signal at or above a preset strength to the user terminal 110. After the communication channel is established between the beacon payment apparatus 120 and the user terminal 110, the signal transmission power of the beacon payment apparatus 120 is increased to the preset strength to facilitate transmission and reception of information with the user terminal 110 even at a long distance. The user terminal 110 can thereby perform authentication even in a state where the user terminal 110 maintains a certain distance from the beacon payment apparatus 120, and when the authentication is successful, the user terminal 110 can use settlement and other services.

The beacon payment apparatus 120 performs settlement at a member store based on the beacon (Bluetooth) of the user terminal 110. The merchant terminal 130 that performs settlement at a typical member store does not support short distance communication. Recently, NFC modules are often installed in the merchant terminal 130.

When the NFC module and the application software are installed in the user terminal 110, the merchant terminal 130 needs to have an NFC module, in order to perform NFC-based payment processing. The merchant terminal 130 needs to be installed with a separate hardware module (NFC module), but payments through NFC have been hardly done in practice. Inconvenience for both users and merchant shops stops an NFC method from leading to actual payments.

The beacon payment apparatus 120 according to the first and second embodiments makes settlement between the user terminal 110 and the merchant terminal 130 by using a beacon (Bluetooth), and it relays signals and authenticates between the terminal 110 and the merchant terminal 130.

The beacon payment apparatus 120 is coupled to a merchant terminal 130 (e.g., POS) in the form of USB. With the merchant terminal 130 having a usual USB port, the beacon payment apparatus 120 is not only easily hooked to the merchant terminal 130 but also saves a big money for the merchant from purchasing a merchant terminal equipped with a separate NFC module.

The beacon payment apparatus 120 according to the first and second embodiments addresses the most important issue that is security in performing the settlement between the user terminal 110 and the merchant terminal 130. In order to resolve the security issue, the beacon payment apparatus 120 performs “restriction on beacon signal transmission range to prevent remote hacking,” “security procedure based on data validation,” “packet recombination,” and “security procedure based on backward data validation.”

<Restriction on Beacon Signal Transmission Range>

The beacon payment apparatus 120 transmits, before establishing a communication channel with the user terminal 110, a beacon (Bluetooth) signal at a predetermined strength to the outside for limiting the beacon transmission range. In addition, upon establishing a communication channel with the user terminal 110, the beacon payment apparatus 120 communicates with the user terminal 110 at signal strength greater than before establishing the communication channel, to increase the beacon transmission range.

The beacon payment apparatus 120 limits the beacon transmission range between the user terminal 110 and the beacon payment apparatus 120 for security in the process of performing settlement by using the beacon.

The beacon payment apparatus 120 transmits a beacon signal only when there is a payment request from the merchant terminal 130. By default, the beacon payment apparatus 120 minimizes the wireless access range against its becoming accessed by a remote site wirelessly (external radio interference and attempted penetration).

The beacon payment apparatus 120 transmits, before establishing a communication channel with the user terminal 110, a beacon (Bluetooth) signal at a predetermined strength to the outside for limiting the beacon transmission range. For example, the beacon payment apparatus 120 limits the wireless access range within a secured access range (e.g., 3 m), and disables access in a range exceeding the secured access range (e.g., 3 m).

After the first wireless connection, the beacon payment apparatus 120 further adjusts the beacon transmission range for safety and efficiency at the next settlement stage. Specifically, upon establishing a communication channel with the user terminal 110, the beacon payment apparatus 120 increases the beacon transmission range by communicating with the terminal with a signal strength that is greater than before establishing the communication channel.

The beacon payment apparatus 120 is to limit the transmission range of the beacon signal taking account of a possible radio disturbance and remotely attempted penetration occurring in a section wirelessly connected to the user terminal 110. The beacon payment apparatus 120 increases the transmission range of the beacon signal exclusively upon receiving the connection signal and the authentication signal from the earnest terminal.

<Security Procedure Based on Data Validation>

A beacon payment apparatus 120 according to the present disclosure receives authentication information from a user terminal 110 through a communication channel established with a user terminal 110. Thereafter, the beacon payment apparatus 120 primarily checks whether the packet structure matches the preset form of packet structure, secondarily checks whether the encrypted form of the authentication information conforms to the preset encryption form, and then outputs the matching/mismatching result.

In order to prevent information leakage and hacking, the beacon payment apparatus 120 performs the data validation process, and releases the connection between the user terminal and the beacon payment apparatus at an unusual situation. When the beacon payment apparatus 120 performs the encryption procedure in the communication between the user terminal 110 and the beacon payment apparatus, and controls to perform the settlement procedure only with appropriate data transmitted from the entitled device are transmitted and received therebetween.

The beacon payment apparatus 120 sets a settlement standby time, and when a valid data is not transmitted within the standby time of payment from the user terminal to the beacon payment apparatus, the beacon payment apparatus 120 terminates a connection between the user terminal and the beacon payment apparatus. The beacon payment apparatus 120 sets a maximum allowable connection time and, in any case when the allowable time elapses, terminates the connection between the user terminal 110 and the beacon payment apparatus 120.

In order to perform the security procedure based on the validation of the data received from the user terminal 110, the beacon payment apparatus 120 primarily confirms the packet structure, secondarily confirms the encryption format, to thereby strengthen security.

<Packet Recombination>

The beacon payment apparatus 120 converts the authentication information and the matching/mismatching result into a data packet, and then transmits the same to the merchant terminal 130 through wired communication.

The beacon payment apparatus 120 rearranges and outputs validated data packets received from the user terminal 110. When the merchant terminal 130 is POS, the beacon payment apparatus 120 rearranges and outputs the validated data packet in compliance with the POS standard, and when the merchant terminal 130 is a CAT, it rearranges and outputs the validated data packet in compliance to the CAT standard.

After examining the validity of the data received by wireless communication with the user terminal 110, the beacon payment apparatus 120 delivers the data only when determining the data are stable, to the wired merchant terminal 130. At this time, the beacon payment apparatus 120 converts and transmits the data into a packet matching the type of the merchant terminal 130.

<Security Procedure Based on Backward Data Validation>

A beacon payment apparatus 120 according to some embodiments receives authentication information and the response data corresponding to the matching/mismatching result from the merchant terminal 130, and checks whether the response data are abnormal, and if not, decomposes the response data to extract an instruction code.

The beacon payment apparatus 120 performs a validation of data transferred from the merchant terminal 130, and transmits exclusively the valid data to the user terminal 110 based on the performing.

The beacon payment apparatus 120 examines the validity of the data received (backward data) from the merchant terminal 130 for any abnormality in the data by performing a second check of the data, and upon determining that the data (backward data) have no abnormality, it decomposes the data and extracts the instruction code for settlement.

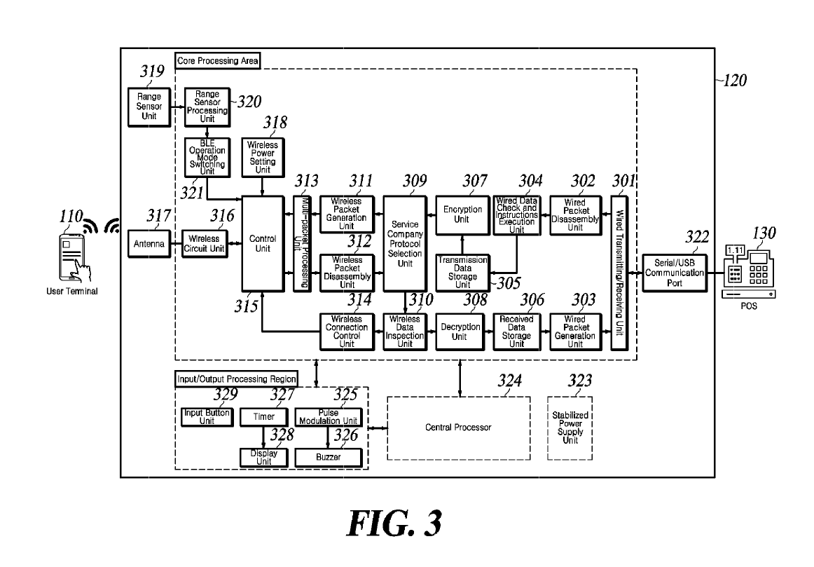

FIG. 3 is a block diagram specifically showing the beacon payment apparatus according to the first and second embodiments.

The beacon payment apparatus 120 according to the first and second embodiments includes an antenna 317, a range sensor unit 319, a communication port 322, a power unit 323 and a central processor 324. Some blocks included in the beacon payment apparatus 120 shown in FIG. 3 may be added, changed, or deleted. For example, the beacon payment apparatus 120 may be implemented without including the range sensor unit 319 and a range sensor processing unit 320.

A wired transmitting/receiving unit 301 is included, which is a module for data communication (for example, wired communication) with the merchant terminal 130. A wired packet disassembling unit 302 is included for decomposing and extracting the data received from the merchant terminal 130, based on the protocol criteria. A wired packet generation unit 303 is provided for generating data complying the protocol standard of the merchant terminal 130. The wired packet generation unit 303 packetizes data to be transmitted to the merchant terminal 130 pursuant to the protocol standard.

A wired data check and instruction execution unit 304 is included for checking wired data as to abnormality of the wired data, and performs data transfer and retransmission according to the confirmation result. When the presence or absence of abnormality of the wired data is confirmed, the wired data check and instruction execution unit 304 executes necessary instructions such as data transfer, beacon apparatus control, retransmission etc. according to the instruction code included in the wired data.

A transmission data storage unit 305 is included to store data to be transmitted to the user terminal 110. A received data storage unit 306 stores the data received from the user terminal 110. An encryption unit 307 encrypts data to be transmitted to the user terminal 110 for secure data exchange with the user terminal 110. The encryption unit 307 performs an encryption process of data to be transmitted using the communication channel established with the user terminal 110. A decryption unit 308 decrypts the data received from the user terminal 110. The decryption unit 308 decrypts data transmitted from the user terminal 110 via an encryption process.

A service company protocol selection unit 309 selects an appropriate protocol for each service provider. For example, a service provider may become a card company server. In case the beacon settlement system 100 is combined with a settlement service, the service company protocol selection unit 309 selects and transmits the protocol used by the settlement service provider to the wireless packet generation unit 311 or the wireless data inspection unit 310.

The wireless data inspection unit 310 examines the validity of the radio data. Only when the format of the authentication information received from the user terminal 110 matches with the preset format, the wireless data inspection unit 310 determines that the wireless data is valid.

The wireless packet generation unit 311 performs a control to generate a wireless packet based on a protocol conforming to the characteristics of the user terminal 110. The wireless packet generation unit 311 processes the encrypted data to generate a packet in conformance with the protocol of the user terminal 110. The wireless packet generating unit 311 generates, based on the encrypted data, a packet including a header, instructions, data, and a checksum conforming to the protocol. The wireless packet disassembly unit 312 decomposes the wireless packet received from the user terminal 110, to extract the data.

The multi-packet processing unit 313 serves to limit the number of packets transmitted and received in the process of communication with the user terminal 110. When transmitting and receiving data once with the user terminal 110 through a beacon (Bluetooth) communication, there is a limitation on the number of packets that the user terminal 110 can transmit and receive, as well as a limitation on the packet size. The multi-packet processing unit 313 processes the number, size, or other attributes of packets of data to be transmitted to or received from the user terminal 110, and thereby it can transmit and receive data to and from the user terminal 110 through the beacon (Bluetooth) communication.

A wireless connection control unit 314 is provided to turn off invalid wireless data or the connection to an unauthorized access. The wireless connection control unit 314 prevents transmission of invalid wireless data. For example, the wireless connection control unit 314 restricts connection with an unauthorized terminal.

A control unit 315 is provided to transmit and receive a beacon signal to and from the user terminal 110 by using the antenna 317. The control unit 315 establishes a communication channel with the user terminal 110 and performs an overall control procedure of data transmitted and received through the established communication channel. The control unit 315 determines whether or not the user terminal 110 exists within the preset range, and if yes, the control unit 315 establishes a beacon-based communication channel with the user terminal 110. The control unit 315 transmits and receives the necessary information for performing the settlement service with the user terminal 110 via the established communication channel.

A wireless circuit unit 316 is provided to match the impedance of the antenna 317 with that of the antenna of the user terminal 110. The antenna 317 transmits and receives information or signals to and from the user terminal 110 via a beacon (Bluetooth) communication.

A wireless power setting unit 318 is provided, serving to adjust the output power of the beacon signal transmitted from the antenna 317. The wireless power setting unit 318 controls to transmit the beacon signal at a preset strength from the antenna 317 until when a communication channel is established between the user terminal 110 and the beacon payment apparatus 120. When a communication channel is established between the user terminal 110 and the beacon payment apparatus 120, the wireless power setting unit 318 outputs a beacon signal transmitted from the complete antenna 317 at an enhanced strength from the value before the channel is established.

The range sensor unit 319 includes a sensor for determining the presence of the user terminal 110 within a preset range. The range sensor processing unit 320 serves to discriminate the presence of the user terminal 110 within the preset range based on the sensed information collected by using the range sensor unit 319.

A BLE operation mode switching unit 321 is provided to switch, based on the determination of the range sensor processing unit 320, the operation mode of the beacon payment apparatus 120 to either a beacon mode (advertise mode) or a connection mode. Here, the beacon mode refers to a mode of periodically broadcasting a beacon signal for detecting a target terminal to connect, and the connection mode refers to a mode for making a one-to-one connection to a specific terminal through a beacon-based communication channel. The serial/USB communication port 322 refers to a communication port for communication connection (e.g., wired connection) with the merchant terminal 130.

The wireless power setting unit 318 sets output power, according to the distance between the beacon payment apparatus 120 and the user terminal 110. The wireless power setting unit 318 controls the beacon signal to be at or below a preset strength so that the user terminal 110 is detectably located within the preset range. When establishing a communication channel with the user terminal 110, the wireless power setting unit 318 controls the output power to be at or above the preset strength.

The range sensor unit 319 detects the distance between the beacon payment apparatus 120 and the user terminal 110. The range sensor processing unit 320 is responsive to when the user terminal 110 is located within the preset range for transmitting a representative signal thereof to the BLE operation mode switching unit 321.

The BLE operation mode switching unit 321 switches operation modes, either to unilaterally transmit a beacon signal received from the range sensor processing unit 320, or to bidirectional communicate with the user terminal 110 by establishing a communication channel with the user terminal 110. The power unit 323 stably supplies power to the beacon payment apparatus 120 from within the beacon payment apparatus 120 or from an external power source. The central processor 324 controls the operation of all components of the beacon payment apparatus 120.

A pulse modulation unit 325 is provided along with a buzzer 326 to generate an input frequency corresponding to the buzzer 326. The pulse modulation unit 325 performs pulse modulation to a frequency used by the buzzer 326 and provides the frequency to the buzzer 326. The buzzer 326 audibly outputs the operation state of the beacon payment apparatus 120. A timer 327 is provided to control the number of times of turning on/off a provided display unit 328 at a constant cycle. The timer 327 turns on or off a provided LED module at a certain cycle based on the timer drive, or controls the number of times of operation or the like. The display unit 328 includes an LED module, and turn on the LED module in a preset color to indicate the state change of the beacon payment apparatus 120. The display unit 328 visually displays the operation state of the beacon payment apparatus 120 by the LED module. An input button unit 329 or simply a button is provided to receive input information concerning the initial setting of the beacon payment apparatus 120.

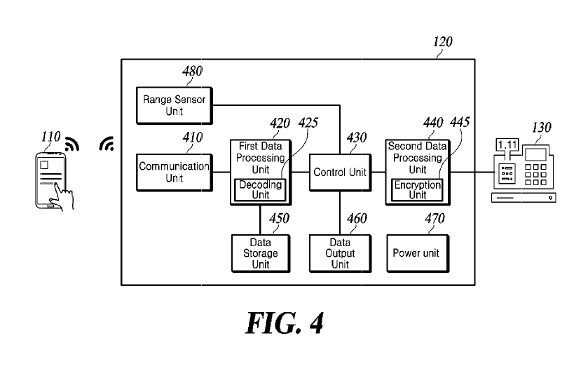

FIG. 4 is a schematic block diagram of a configuration of the beacon payment apparatus according to the first embodiment.

The beacon payment apparatus 120 according to the first embodiment includes a communication unit 410, a first data processing unit 420, a control 430, a second data processing unit 440, a data storage unit 450, a data output unit 460, a power unit 470 and a range sensor unit 480.

The communication unit 410 transmits and receives information and signals to and from the user terminal 110 through beacon (Bluetooth) communications. The communication unit 410 transmits a beacon signal to the user terminal 110 and establishes a beacon-based communication channel with the user terminal 110 to receive a connection signal and authentication information from the user terminal 110. Further, the communication unit 401 receives an authentication operation request signal from the merchant terminal 130.

The first data processing unit 420 generates a packet according to the protocol of the user terminal 110 based on the encrypted data to be transmitted to the user terminal 110. The first data processing unit 420 receives the encrypted data to be transmitted from the second data processing unit 440 to the user terminal 110. The first data processor 420 generates, based on the received data, a packet having its header, instructions, data, and checksum that conforms to the protocol of the user terminal 110.

The first data processor 420 disassembles the packet received from the user terminal 110 and extracts necessary data. The first data processing unit 420 includes a decryption unit 425. Since the data received from the user terminal 110 are encrypted, the decryption unit 425 decrypts the packet received from the user terminal 110. The first data processing unit 420 decomposes the packet decoded by the decryption unit 425 and extracts the data.

Upon receiving the authentication operation request signal, the control unit 430 controls the communication unit 410 to transmit the beacon signal. The control unit 430 controls the communication unit 410 to transmit beacon signals omnidirectionally. When the distance between the user terminal 110 and the beacon payment apparatus 120, detected by the range sensor unit 480 is within a preset range or when the communication unit 410 receives a connection signal from the user terminal 110, the control unit 430 controls to establish the beacon-based communication channel between the user terminal 110 and the beacon payment apparatus.

The control unit 430 controls the communication unit 410 to transmit beacon signals omnidirectionally, but at a predetermined intensity or less. The control unit 430 controls the beacon signals to be transmitted at a predetermined intensity or less so that the user terminal 110 is detectably located within a predetermined distance from the beacon payment apparatus 120. Meanwhile, the control unit 430 controls the output power of the signal to be equal to or greater than a predetermined intensity after the beacon communication-based communication channel is established with the user terminal 110.

Upon receiving the authentication information from the user terminal 110, the control unit 430 determines whether or not the received authentication information conforms to the format of the received authentication information. When the format of the received authentication information is appropriate, the control unit 430 controls to transmit the result of matching authentication information to the merchant terminal 130. On the contrary, when the received authentication information is not properly formatted, the control unit 430 controls to close the communication channel established with the user terminal 110.

The control unit 430 performs instructions such as data transmission, control of the beacon payment apparatus, and retransmission of data according to the instruction code extracted by the second data processing unit 440. The second data processing unit 440 may extract an instruction code from data received from the merchant terminal 130, and the control unit 430 executes instructions included in the extracted instruction code.

The control unit 430 compares the authentication information received from the user terminal 110 with the authentication information stored in the data storage unit 450 to determine whether the user terminal 110 is a terminal registered to use a payment or other services. When the two authentication information items match each other, the control unit 430 may determine that the user terminal 110 is a registered terminal entitled to use the payment or other services. On the contrary, when the two authentication information items do not match, the control unit 430 may determine that the user terminal 110 is not entitled to use the payment or other services. The control unit 430 may transmit the determination result to the merchant terminal 130. The merchant terminal 130 may determine whether to proceed with settlement or other services based on the determination result.

The second data processing unit 440 processes the data to be transmitted to the merchant terminal 130 in conformance with the protocol standard of the merchant terminal 130. The authentication information received from the user terminal 110 or the matching/nonmatching result from or the determination result by the control unit 430 corresponds to the data conforming to the protocol standard of the merchant terminal 130. Accordingly, the second data processing unit 440 so processes the authentication information received from the user terminal 110 or the matching/nonmatching result from or the determination result by the control unit 430 as to match the protocol standard of the merchant terminal 130. The second data processing unit 440 transmits the processed information or the result to the merchant terminal 130.

The second data processing unit 440 confirms whether there is an abnormality in the data received from the merchant terminal 130, and disassembles the data to extract the necessary data. The second data processing unit 440 extracts, after confirming the abnormality of the wired data, the instruction code in the data received from the merchant terminal 130, and transmits the extracted instruction code to the control unit 430.

The second data processing unit 440 includes an encryption unit 445. The data to be transmitted to the user terminal 110 among the necessary data extracted by the second data processing unit 440 is not encrypted. Therefore, the encryption unit 445 encrypts the data to be transmitted to the user terminal 110.

The data storage unit 450 may temporarily store data in existence or occurring before or during data processing by the first data processing unit 420 or the second data processing unit 440. For example, when the first data processing unit 420 attempts to disassemble a packet received from the user terminal 110 and extract necessary data, the data storage unit 450 may store the packet received from the user terminal 110 until the first data processing unit 420 disassembles it.

The data storage unit 450 may receive and store authentication information of terminals registered to use payment or other services from the backend server 140 or an external server (not shown). The data storage unit 450 receives and stores the authentication information, and thereby allows the control unit 430 to determine whether the user terminal 110 is a registered terminal entitled to use the payment or other services.

The data output unit 460 outputs externally whether the user terminal 110 is located within a predetermined distance to the beacon payment apparatus 120, according to the detected value of the range sensor unit 480. The data output unit 460 outputs externally whether a communication channel with the user terminal 110 is established. The data output unit 460 externally outputs whether or not the authentication information conforms to the preset format. The data output unit 460 outputs externally whether the user terminal 110 is a registered terminal so as to use payment or other services.

The data output unit 460 may include a light emitting module such as a LED or a sound module such as a buzzer. For example, when establishing the communication channel with the user terminal 110, the data output unit 460 may output a specific sound or emit light of a specific color.

The power supply unit 470 stably supplies power to the beacon payment apparatus 120 from within the beacon payment apparatus 120 or from an external power source.

The range sensor unit 480 includes a light emitting sensor and a light receiving sensor and detects a distance value between the user terminal 110 and the beacon payment apparatus 120. The range sensor unit 480 detects the distance value and transmits the detected distance value to the control unit 430 which can then control establishment of the communication channel by the user terminal 110.

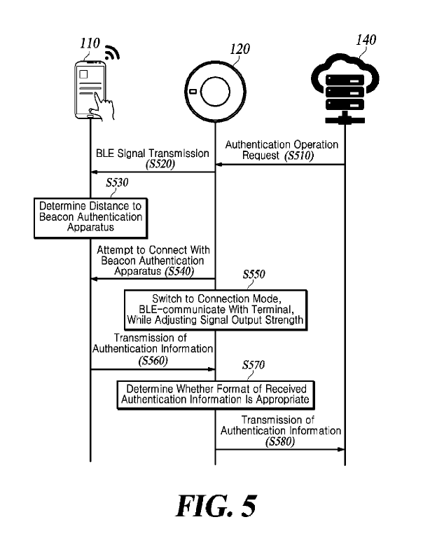

FIG. 5 is a flowchart illustrating a method of authenticating a terminal by the beacon payment apparatus according to the first embodiment.

The backend server 140 transmits an authentication operation request signal to the beacon payment apparatus 120 (Step S510). The backend server 140 transmits the authentication operation request signal to the beacon payment apparatus 120 via the merchant terminal 130.

The beacon payment apparatus 120 transmits a beacon signal to the user terminal 110 upon receiving the authentication operation request signal (S520). When the beacon payment apparatus 120 receives the authentication operation request signal, it transmits a beacon signal omnidirectionally so that various terminals can receive it. The beacon payment apparatus 120 includes an identifier such as a universally unique identifier (UUID) in transmitting the beacon signal so that the user terminal 110 can identify the beacon payment apparatus 120.

The user terminal 110 determines the distance to the beacon payment apparatus 120 (S530). The user terminal 110 determines a distance between the user terminal 110 and the beacon payment apparatus 120 based on a received signal strength indication (RSSI) of the received BLE signal.

When the distance between the user terminal 110 and the beacon payment apparatus 120 is within a predetermined range, the user terminal 110 attempts to establish a communication connection with the beacon payment apparatus 120 by transmitting a connection signal to the beacon payment apparatus 120 (S540).

The beacon payment apparatus 120 establishes a beacon-based communication channel with the user terminal 110 in Step S550. The beacon payment apparatus 120 may transmit and receive information and signals to and from the user terminal 110 having a communication channel established. The beacon payment apparatus 120 may control to differentiate the signal strength when omnidirectionally transmitting a beacon signal for establishing a communication channel, from the signal strength when transmitting information or signals to the user terminal 110 after establishing the communication channel. The beacon payment apparatus 120 may control the output power to be equal to or greater than a predetermined intensity when a communication channel is established with the user terminal 110.

The user terminal 110 transmits the authentication information to the beacon payment apparatus 120 (S560).

The beacon payment apparatus 120 determines whether the format of the authentication information received from the user terminal 110 is appropriate (S570). The beacon payment apparatus 120 determines whether or not the packet structure of the authentication information received from the terminal conforms to the packet structure of the preset format and/or whether the encrypted format of the authentication information matches the preset format. When the packet structure of the authentication information received from the terminal does not match the packet structure of the preset format, or when the encrypted format of the authentication information does not conform to the preset format, the beacon payment apparatus 120 closes the established communication channel.

The beacon payment apparatus 120 transmits the authentication information to the backend server 140 (S580). When the packet structure of the authentication information received from the terminal matches the packet structure of the preset format and the encrypted format of the authentication information conforms to the preset format, the beacon payment apparatus 120 transmits the authentication information received from the terminal as well as the matching/mismatching result to the backend server 140 via the merchant terminal 130.

FIG. 5 illustrates that the beacon payment apparatus 120 and the backend server 140 are directly interconnected. However, the beacon payment apparatus 120 and the backend server 140 are not necessarily limited thereto, and the merchant terminal 130 may be connected between the beacon payment apparatus 120 and the backend server 140 as in FIG. 1.

Although the steps in FIG. 5 are described to be sequentially performed, they merely instantiate the technical idea of some embodiments of the present disclosure. Therefore, a person having ordinary skill in the pertinent art could appreciate that various modifications, additions, and substitutions are possible by changing the sequences described in the respective drawings or by performing two or more of the steps in parallel, without departing from the gist and the nature of the embodiments of the present disclosure, and hence the steps in FIG. 5 are not limited to the illustrated chronological sequence.

The steps shown in FIG. 5 can be implemented as computer-readable codes on a computer-readable recording medium. The computer-readable recording medium includes any type of recording device on which data that can be read by a computer system are recordable.

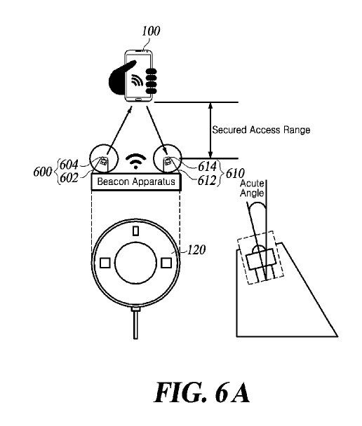

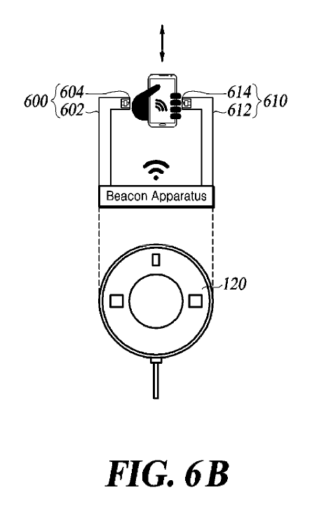

FIG. 6A and FIG. 6B are diagrams of beacon payment apparatuses each including a range sensor, according to the second embodiment.

As shown in FIG. 6, the beacon payment apparatus 120 when implemented, may be further provided with a sensor device for determining the existence of the user terminal 110 within a predetermined range based on an optical signal. Referring to FIG. 3, the sensor device may be a range sensor unit 319 and a range sensor processing unit 320. FIG. 6A is a diagram illustrating components of the range sensor unit 319 based on the distance measurement method. FIG. 6B is a diagram illustrating the components of the range sensor unit 319 based on the object detection method.

The beacon payment apparatus 120 according to the second embodiment needs the presence of the user terminal 110 within the secured access range, to establish a communication channel by beacon communication with the user terminal 110, to transmit settlement request information to the terminal through the communication channel and then receive settlement response information corresponding to the settlement request information from the terminal, and to transmit settlement response information corresponding to the settlement request information received from the merchant terminal 130, to the merchant terminal 130.

The beacon payment apparatus 120 makes wireless communication by way of beacon between the user terminal 110 and the beacon payment apparatus 120. This provides the basis for wired communications performed between the beacon payment apparatus 120 and the merchant terminal 130 including the POS, so that the beacon payment processing can be performed with the user terminal 110 even by a POS lacking a separate beacon module.

Security is most important in the process of making beacon payments with the user terminal 110 even by the merchant terminal 130 lacking a separate beacon module, and therefore the beacon payment apparatus 120 establishes a communication channel with the user terminal 110 exclusively when it is determined that the communication channel is within the secured access range.

In other words, it is important to limit the range of distance at which the beacon payment apparatus 120 recognizes the user terminal 110 to within the secured access range. Since the beacon payment apparatus 120 ultimately establishes a communication channel with the user terminal 110 in order to process the payment request made by beacon from the user terminal 110, it is important to limit the wireless access range within the secured access range (e.g., about 1 m) and make the relevant devices inaccessible from within the range beyond thereof, in order to prevent hacking approaches.

Thus, the beacon payment device 120 utilizes a “first configuration” or a “second configuration” of the range sensor provided, to confirm that the user terminal 110 is within the secured access range (e.g., about 1 m).

With a typical range sensor, the distance between the user terminal 110 and the beacon payment apparatus 120 cannot be accurately recognized. On the other hand, the range sensor according to the second embodiment features a “first configuration” which enables light emitting and light receiving operations through symmetrical acute angle structures facing the same direction, and a “second configuration” which enables light emitting and light receiving operations through right angled arm structures erected from a plane so as to face a preset common point.

As shown in FIG. 6A, the range sensor unit 319 based on the distance measurement method includes a light emitting unit 600 and a light receiving unit 610.

The light emitting unit 600 includes a first projection 602 and a light emitting element 604. The first projection 602 is formed at the first end outside the beacon payment apparatus 120 so as to protrude outward of the beacon payment apparatus 120. The light emitting device 604 is coupled to the first projection 602 in its protruding direction, and irradiates an optical signal toward the user terminal 110.

The light receiving unit 610 includes a second projection 612 and a light receiving element 614. The second projection 612 is formed on the second end of the beacon payment apparatus 120 outside the beacon payment apparatus 120 so as to protrude outward. The light receiving element 614 receives an echo signal corresponding to the optical signal reflected from the user terminal 110.

The first projection 602 and the second projection 612 are spaced apart from each other by a predetermined distance, and are formed to be inclined by a predetermined angle to the same point. For example, the first projection 602 and the second projection 612 may be embodied in the shape of □□. The first projection 602 and the second projection 612 are so inclined by a predetermined angle as to provide increased amount of optical signals reflected from the user terminal 110.

When based on the distance measurement method, the range sensor unit 319 determines the presence/absence of the user terminal 110 within a preset range based on the difference between the time when the optical signal is emitted from the light emitting element 604 and the time when the echo signal is received by the light receiving element 614.

The following describes the beacon payment apparatus 120 including the distance measurement unit 730 having a first configuration.

The beacon payment apparatus 120 may include a distance measurement unit 730, a close-range terminal determination unit 700, a communication setting unit 740, a user terminal signal processing unit 710 and a payment terminal signal processing unit 720.

The distance measurement unit 730 has a first structure which enables light emitting and light receiving operations through symmetrical acute angle substructures facing the same direction. The close-range terminal determination unit 700 determines whether a user terminal exists within the secured access range according to whether the user terminal 110 enters the first structure. The communication setting unit 740 establishes a beacon-based communication channel with the user terminal 110 when it is determined that the user terminal 110 exists within the secured access range. The user terminal signal processor 710 transmits the settlement request information to the user terminal 110 through the communication channel, and receives the settlement response information corresponding to the settlement request information from the user terminal 110. The payment terminal signal processor 720 transmits settlement response information through wired communications to the merchant terminal 130 in response to settlement request information received from the merchant terminal 130.

Based on the first structure which enables light emitting and light receiving operations through symmetrical acute angle substructures facing the same direction, the beacon payment apparatus 120 provides the beacon-based settlement service exclusively when the user terminal 110 enters the secured access range. When the close-range terminal determination unit 500 determines that the user terminal 110 enters within the secured access range due to the first structure of the range sensor, the communication setting unit 540 establishes a communication channel with the user terminal 110, whereby the settlement process is subsequently performed.

As shown in FIG. 6A, the beacon payment device 120 includes a light-emitting unit 600 formed to be inclined at a preset acute angle toward the [symbol] direction, and a light receiving unit 610 formed to be inclined at a predetermined acute angle toward the [symbol] direction which is symmetrical to the [symbol] direction. The beacon payment apparatus 120 does not simply detect the beacon signal from the user terminal 110 but determines the distance of the user terminal 110 separately to perform the beacon settlement. At this time, the distance measurement unit 730 has structural feature that leads the user terminal 110 to unmistakably enter the common point to which the light emitting unit 600 and the light receiving unit 610 are directed through their joint [symbol] [symbol] structure (within a secured access range).

As shown in FIG. 6B, the range sensor unit 319 based on the object detection method includes a light emitting unit 600 and a light receiving unit 610.

The light emitting unit 600 includes a first projection 602 and a light emitting element 604. The first projection 602 protrudes toward the outer side of the beacon payment apparatus 120 at the first end of the beacon payment apparatus 120, and is bent to the center. The light emitting element 604 is coupled to the first projection 602 at its protruding end, and irradiates an optical signal toward the user terminal 110.

The light receiving unit 610 includes a second projection 612 and a light receiving element 614. The second projection 612 protrudes toward the outside of the beacon payment apparatus 120 at the second end of the beacon payment apparatus 120, and is bent to the center. The light receiving element 614 receives an echo signal corresponding to the optical signal reflected from the user terminal 110.

The first projection 602 and the second projection 612 are spaced apart from each other by a predetermined distance, and they are formed to face each other with the predetermined distance therebetween.

When based on the object detection method, the range sensor unit 319 determines the presence/absence of the user terminal 110 according to whether the user terminal 110 enters the space formed between the first and second projections 602 and 612. For example, when the optical signal irradiated from the light emitting element 604 is not received by the light receiving element 614, the range sensor unit 319 determines that the user terminal 110 has entered the space formed between the first projection 602 and the second projection 612.

Where the object detection-based range sensor unit 319 is provided, the user of the user terminal 110 is led to enter the space formed between the first projection 602 and the second projection 612. Such simple motion alone can have the presence of the user terminal 110 recognized by the beacon payment apparatus 120 according to some embodiments.

The following describes a beacon payment apparatus 120 including a distance measurement unit 730 having a second structure.

The beacon payment apparatus 120 is connected to the merchant terminal 130 to provide a payment service. The beacon payment apparatus 120 include the distance measurement unit 730, close-range terminal determination unit 700, communication setting unit 740, user terminal signal processing unit 710 and payment terminal signal processing unit 720. The distance measurement unit 730 has a second structure which enables light emitting and light receiving operations through right angled arm substructures erected from a plane so as to face a preset common point. The close-range terminal determination unit 700 determines whether the user terminal 110 exists within the secured access range according to whether the user terminal 110 enters the second structure. The communication setting unit 740 establishes a beacon-based communication channel with the user terminal 110 when it is determined that the user terminal 110 exists within the secured access range. The user terminal signal processor 710 transmits the settlement request information to the user terminal 110 through the communication channel, and receives the settlement response information corresponding to the settlement request information from the user terminal 110. The payment terminal signal processor 720 transmits the settlement response information through wired communications to the merchant terminal in response to the settlement request information received from the merchant terminal 130.

Based on the second structure which enables light emitting and light receiving operations through right angled arm substructures erected from the plane so as to face the preset common point, the beacon payment apparatus 120 provides beacon-based settlement services exclusively when the user terminal 110 enters the secured access range. When the close-range terminal determination unit 500 determines that the user terminal 110 enters within the secured access range due to the second structure of the range sensor, the communication setting unit 540 establishes a communication channel with the user terminal 110, to subsequently carry out the payment processing.

As shown in FIG. 6B, the beacon payment device 120 includes a light emitting unit 600 formed into a [symbol] -shape that is projected outward and bent in the middle, and a light receiving unit 610 formed into a [symbol] -shape that is projected outward and bent in the middle so as to be symmetrical with the [symbol] -shape. In other words, the beacon payment device 120 has a structural feature to ensure the user terminal 110 to enter the same point where the [symbol] structure (within the secured access range) formed by the light emitting unit 600 and the light receiving unit 610 is destined.

The beacon payment apparatus 120 according to the second embodiment does not simply detect the beacon signal from the user terminal 110 but also separately determines the distance to the user terminal 110 to perform beacon settlement. In this case, the distance measurement unit 730 has a structural feature for the user terminal 110 to unmistakably enter the same point where the [symbol] structure (within the secured access range) formed by the light emitting unit 600 and the light receiving unit 610 is destined.

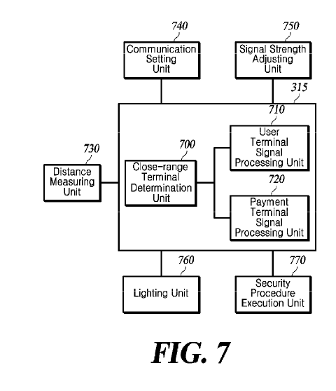

FIG. 7 is a block diagram schematically showing a control unit of the beacon payment apparatus according to the second embodiment.

The control unit 315 of the beacon payment apparatus 120 according to the present embodiment includes the close-range terminal determination unit 700, user terminal signal processing unit 710 and payment terminal signal processing unit 720. FIG. 7 illustrates a communication setting unit 740, a signal strength adjusting unit 750 and a lighting unit 760 which will not be detailed because they correspond to the components, as in FIG. 3, of the BLE operation mode switching unit 321, the wireless power setting unit 318 and the display unit 328, respectively. FIG. 7 illustrates a security procedure execution unit 770 which corresponds to the encryption unit 307 and the decryption unit 308 shown in FIG. 3. FIG. 7 illustrates the distance measurement unit 730 corresponding to the range sensor unit 319 and the range sensor processing unit 320 shown in FIG. 3.

The close-range terminal determination unit 700 determines whether the user terminal 110 exists within a predetermined range.

When lacking a range sensor, the close-range terminal determination unit 700 determines whether the user terminal 110 is present depending on the receipt or non-receipt of a feedback signal fed back from the user terminal 110 in response to the beacon signal transmitted from the beacon payment apparatus 120.

In the second embodiment, the close-range terminal determination unit 700 determines whether the user terminal 110 exists based on the sensed information measured by using the distance measurement unit 730.

Different methods of determining the presence/absence of the user terminal 110 depending on whether the close-range terminal determination unit 700 has the range sensor are equivalent to the aforementioned manner in which the beacon payment apparatus 120 determines the presence/absence of the user terminal 110, and a second description thereof will be omitted.

The user terminal signal processing unit 710 transmits the settlement request information to the user terminal 110 through the communication channel between the user terminal 110 and the beacon payment apparatus 120, established by using the communication setting unit 740.

Similarly, the user terminal signal processing unit 710 receives settlement response information corresponding to the settlement request information from the user terminal 110 through a communication channel established between the user terminal 110 and the beacon payment apparatus 120.

The payment terminal signal processor 720 receives settlement request information from the merchant terminal 130 in advance through wired communications.

Similarly, the payment terminal signal processor 720 relays the settlement response information received from the user terminal 110 to the merchant terminal 130 through wired communications.

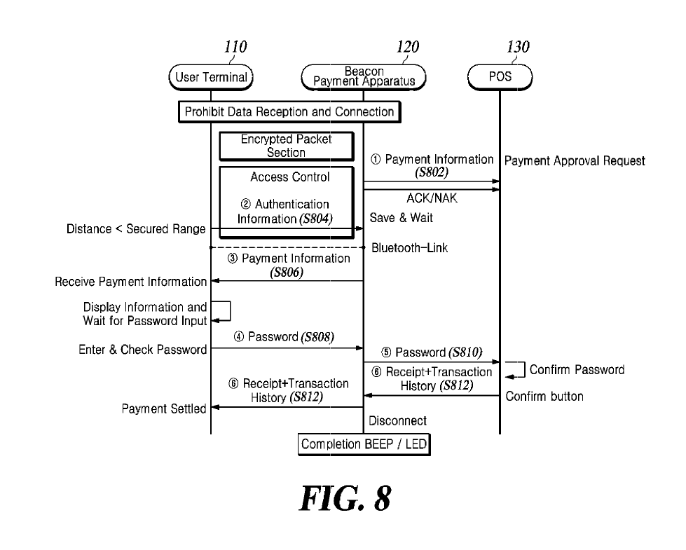

FIG. 8 is a timing chart for explaining a payment method performed by the beacon payment apparatus when lacking a range sensor, according to the second embodiment.

The beacon payment apparatus 120 receives settlement request information for an article purchased by the user, from the merchant terminal 130 through wired communications (S802). The settlement request information includes purchase items purchased by the user, price information on the purchased items, and user information.

The beacon payment apparatus 120 establishes a beacon-based communication channel with the user terminal 110 when it is determined that the user terminal 110 exists within a predetermined range (S804). In Step S804, the beacon payment apparatus 120 determines the presence/absence of the user terminal 110 within a predetermined range depending on receipt or non-receipt of, for example, authentication information or other feedback signals fed back from the user terminal 110 in response to a beacon signal transmitted from beacon payment apparatus 120. The beacon payment apparatus 120 performs the authentication procedure for the user terminal 110 based on the authentication information included in the feedback signal, and determines whether to maintain the communication channel with the user terminal 110 according to the authentication result.

The beacon payment apparatus 120 transmits the settlement request information received in Step S802 to the user terminal 110 through the communication channel established in Step S804 (S806). The user terminal 110 displays the settlement request information received in Step S806 to the user, and receives settlement response information corresponding to the settlement request information from the user. On the other hand, in Step S806, it is assumed that the settlement response information is a password set in advance for allowing a settlement using a specific settlement means to be performed.

The user terminal 110 transmits the preset password as the settlement response information corresponding to the settlement request information, to the beacon payment apparatus 120 through the communication channel established in Step S804 (S808).

The beacon payment apparatus 120 transmits the password received in Step S808 to the merchant terminal 130 through wired communications (S810). The merchant terminal 130 performs a settlement procedure for the goods purchased by the user by using the password received in Step S810.

The merchant terminal 130 transmits information on the transaction history of the settlement procedure performed in Step S810 to the user terminal 110 via the beacon payment apparatus 120.

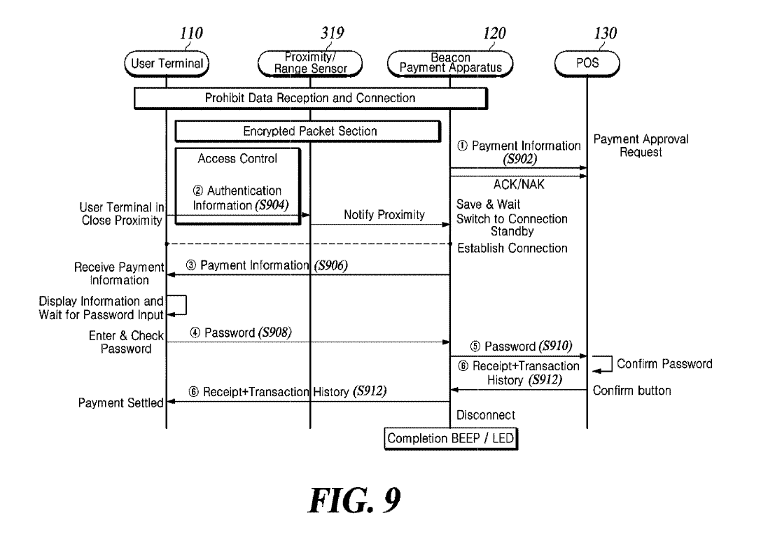

FIG. 9 is a timing chart for explaining a payment method performed by the beacon payment apparatus when provided with the range sensor according to the second embodiment.

The payment method, when the beacon payment apparatus 120 includes a range sensor, is only different from that of FIG. 8 by the beacon payment apparatus 120 determining whether or not the user terminal 110 exists within a predetermined range in Step S904, and the detailed description of the remaining steps except Step S904 will be omitted.

The beacon payment apparatus 120 includes a range sensor, and utilizes the same for determining whether the user terminal 110 exists within a predetermined range (S904). In Step S904, the beacon payment apparatus 120 may determine whether the user terminal 110 exists within a preset range by using the distance measurement method based on the sensed information collected by using the range sensor. In some embodiments, the beacon payment apparatus 120 determines whether the user terminal 110 exists within a predetermined range by using the object detection method based on the sensed information collected by using the range sensor.

Although exemplary embodiments of the present disclosure have been described for illustrative purposes, those skilled in the art will appreciate that various modifications, additions and substitutions are possible, without departing from the idea and scope of the claimed invention. Therefore, exemplary embodiments of the present disclosure have been described for the sake of brevity and clarity. The scope of the technical idea of the present embodiments is not limited by the illustrations. Accordingly, one of ordinary skill would understand the scope of the claimed invention is not to be limited by the above explicitly described embodiments but by the claims and equivalents thereof.

1. An apparatus for payment using a beacon, the apparatus comprising:
a wireless communication unit configured to transmit a beacon signal externally at a preset signal strength, and receive a connection signal corresponding to the beacon signal from a terminal located nearby;
a control unit configured to control, upon receiving the connection signal, to establish a communication channel based on a beacon communication with the terminal;
a first data processing unit configured to determine whether the authentication information conforms to or matches with a preset format, and generate a matching/mismatching result; and
a second data processing unit configured to convert the authentication information and the matching/mismatching result into data packets, and transmit the data packets to the payment terminal through wired communications.

2. The apparatus of claim 1, wherein the control unit is configured to control to transmit the beacon signal at or below a predetermined threshold value until when establishing the communication channel with the terminal.

3. The apparatus of claim 1, wherein the control unit is configured to control to transmit the beacon signal at a signal strength exceeding a predetermined threshold value upon establishing the communication channel with the terminal.

4. The apparatus of claim 1, wherein the authentication information has a packet structure and is encrypted.

5. The apparatus of claim 1, further comprising:
a decryption unit configured to receive and decrypt the authentication information from the first data processing unit, and transfer decrypted authentication information to the second data processing unit.

6. The apparatus of claim 1, further comprising:
a data output unit configured to output externally, information on whether or not a communication channel is established with the terminal or matching/mismatching result.

7. A method of performing, by a beacon payment apparatus, a beacon-based settlement, the method comprising:
transmitting a beacon signal externally at a preset signal strength, and receiving a connection signal corresponding to the beacon signal from a terminal located nearby;
controlling, upon receiving the connection signal, to establish a communication channel based on a beacon communication with the terminal;
determining whether the authentication information conforms to or matches with a preset format, and generating a matching/mismatching result; and
converting the authentication information and the matching/mismatching result into data packets, and transmitting the data packets to the payment terminal through wired communications.

8. A beacon payment apparatus, comprising:
a first projection formed at one end outside the beacon payment apparatus so as to protrude toward an outward direction having a predetermined acute angle;
a second projection protruding in the same direction as the first projection;
a light emitting unit coupled to a protruding end of the first projection to illuminate an object positioned in a predetermined acute angle direction with an optical signal;
a light receiving unit coupled to a protruding of the second projection to receive an echo signal reflected from the object, corresponding to the optical signal; and
a close-range terminal determination unit configured to determine the object based on the presence or absence of the echo signal reflected from the object within a secured access range in a direction in which the first projection and the second projection are directed.

9. A beacon payment apparatus, comprising:
a first projection formed at one outside end of the beacon payment apparatus so as to protrude upright from the beacon payment apparatus until being bent toward a center of the beacon payment apparatus;
a second projection protruding upright from an opposite outside end of the beacon payment apparatus until being bent toward the center of the beacon payment apparatus, the second projection facing the first projection;
a light emitting unit coupled to a protruding end of the first projection to illuminate an object positioned in a predetermined acute angle direction with an optical signal;
a light receiving unit coupled to a protruding of the second projection to receive an echo signal reflected from the object, corresponding to the optical signal; and
a close-range terminal determination unit configured to determine the object based on the presence or absence of the echo signal reflected from the object within a secured access range in a direction in which the first projection and the second projection are directed.
